(19) United States
(12) Patent Application Publication
(10) Pub. No.: US 2007/0281507 A1
(43) Pub. Date: Dec. 6, 2007

(54) IC contact for LGA socket

(75) Inventors: Fang-Jwu Liao, Tu-Cheng (TW); Hao-Yun Ma, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/810,243

(22) Filed: Jun. 5, 2007

(30) Foreign Application Priority Data
Jun. 5, 2006 (TW) 95209740

(51) Int. Cl. H01R 12/00

(52) U.S. Cl. 439/71

(57) ABSTRACT

An IC contact (1) for use in an LGA socket includes a retention portion (10), a contact portion (11) extending from the retention portion, a solder terminal portion (12) extending opposite to the contact portion, and a connecting section (13) connected between the retention portion and the solder terminal portion. The connecting section is bent from a sheet of material and configured to have a multi-curved shape. Such a multi-curved connecting section does provide a high contact force for deflection, and is capable of attaining high compliance, thereby having no portion cracked during a reflow solder process.

### BACKGROUND OF THE INVENTION

1. Field of the Invention

The present invention relates to the art of electrical connectors, and more particularly to an IC contact for use in an LGA socket for improving its flexibility.

2. Description of the Related Art

Various types of connectors have been developed for electrical connections to an IC package and a printed circuit board, such as Pin Grid Array (PGA) connectors, Ball Grid Array (BGA) connectors, Land Grid Array (LGA) connectors, etc., the names of which are assigned thereto based on conductive elements of the IC package that connectors electrically connect. Contacts resided within the respective connectors are accordingly classified as PGA contacts, BGA contacts, LGA contacts and so on.

As shown in FIG. 2, one conventional IC contact 1′ for use in an LGA socket includes a retention portion 10′, a contact portion 11′ extending from the retention portion 10′ and adapted to engage a mating contact of an LGA package (not shown), and a solder terminal portion 12′ disposed opposite to the contact portion and adapted to receive soldering material, such as a solder ball, to be fused thereon. The solder terminal portion 12′ is attached to the retention portion 10′ by a short beam 13′.

A problem, however, with the IC contact 1′ is that the solder terminal portion 12′ is apt to be cracked or broken from the retention portion 10′ of the IC contact 1′ when the solder terminal portion 12′ undergoes a reflow solder process during which a solder ball is to be fused onto the solder terminal portion 12′. This is so because the beam 13′, in form of a single curved part, often does not provide a high contact force for deflection or adequate spring property, and is unable to attain high compliance. Therefore, there is a need to provide a new IC contact to resolve the above-mentioned shortcomings.

### SUMMARY OF THE INVENTION

An IC contact for use in an LGA socket is provided according to an embodiment of the present invention. The IC contact includes a retention portion, a contact portion, a solder terminal portion, and a connecting section. The contact portion extends from the retention portion, and adapted to engage a mating contact of an LGA package. The solder terminal portion extends opposite to the contact portion and adapted to receive soldering material to be fused thereon. The connecting section is connected between the retention portion and the solder terminal portion. The connecting section is bent from a sheet of material and configured to have a multi-curved shape. As compared with the prior art, with the configuration of the connecting section being of a multi-curved shape, such a connecting section for connecting the retention portion and the solder terminal portion does provide a high contact force for deflection or adequate spring property, and is capable of attaining high compliance, thereby having no portion cracked during a reflow solder process.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is a perspective view of an IC contact for use in an LGA socket according to a preferred embodiment of the present invention; and

FIG. 2 is a perspective view of a conventional IC contact.

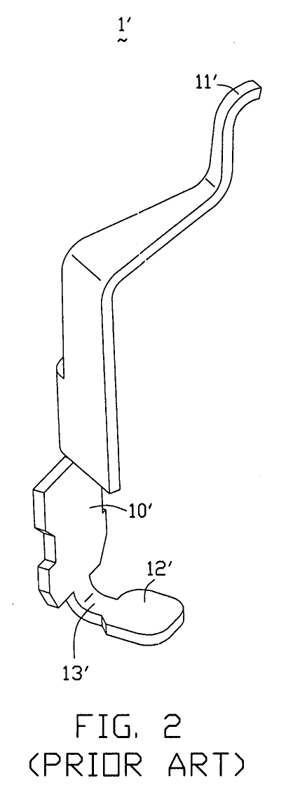

### DETAILED DESCRIPTION OF PREFERRED EMBODIMENT

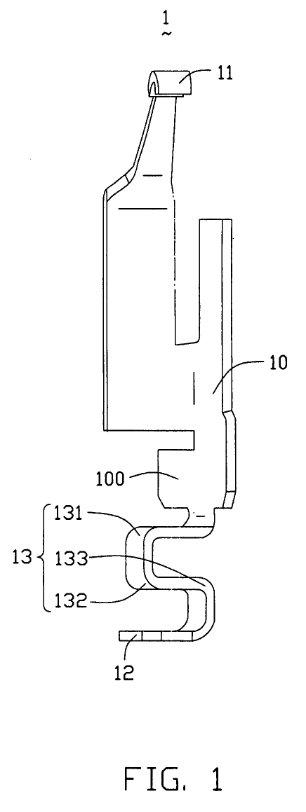

Referring to FIG. 1, an IC contact 1 for use in an LGA socket (not shown) is shown according to the preferred embodiment of the present invention. The IC contact 1 includes a middle retention portion 10, an upper contact portion 11, a low solder terminal portion 12, and a connecting section 13. The middle retention portion 10 includes a plurality of barbs 100 formed on opposite side edges thereof for being retained in a passageway of the LGA socket so as to hold the IC contact 1 within the LGA socket. The upper contact portion 11 extends from the retention portion 10 and adapted to engage a mating contact (not shown) of the LGA socket. The low solder terminal portion 12 is disposed opposite to the upper contact portion 11, and is of a planar configuration adapted to receive a soldering material, such as a solder ball, to be fused thereon. In this embodiment, the planar solder terminal portion 12 is substantially perpendicular to the retention portion 10. The connecting section 13 extends between the retention portion 10 and the low solder terminal portion 12. In this embodiment, the connecting section 13 is bent from a sheet of material, generally as a metal material or plated with a metal material, and configured to have a multi-curved shape, i.e. including curved parts 131, 132 and 133. As shown in FIG. 1, these curved parts 131, 132 and 133 are combined to include at least one C-shaped structure. As compared with the prior art, with the configuration of the connecting section 13 being of a multi-curved shape, such a connecting section 13 for connecting the retention portion 10 and the solder terminal portion 12 does provide a high contact force for deflection or adequate spring property, and is capable of attaining high compliance, thereby having no portion cracked during a reflow solder process.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An IC contact for use in an LGA socket, the IC contact comprising:
a retention portion;
a contact portion extending from the retention portion and adapted to engage a mating contact of an LGA package;
a solder terminal portion extending opposite to the contact portion and adapted to receive soldering material to be fused thereon;
a connecting section connected between the retention portion and the solder terminal portion, the connecting section being bent from a sheet of material and configured to have a multi-curved shape.

2. The IC contact as recited in claim 1, wherein the connecting section includes at least one C-shaped structure.

3. The IC contact as recited in claim 1, wherein the solder terminal potion is of a planar configuration.

4. The IC contact as recited in claim 3, wherein the retention portion is substantially perpendicular to the solder terminal portion.

5. The IC contact as recited in claim 1, wherein the solder terminal portion is adapted to receive a solder ball.

6. The IC contact as recited in claim 1, wherein the retention portion includes a plurality of barbs formed on opposite side edges thereof.

7. An IC contact comprising:
a planar retention portion having barbs thereon;
a resilient contacting portion extending from a side of said retention portion;
a serpentine tail portion extending from a bottom end of the retention portion with a horizontal solder plane at the bottom end thereof; wherein the whole serpentine tail portion is perpendicular to a common plane to which the retention portion is perpendicular.

8. The IC contact as claimed in claim 7, wherein thickness directions defines by the whole serpentine tail portion are parallel to the common plane.

9. The IC contact as claimed in claim 7, wherein said serpentine tail portion is S-shaped from a view normal to said common plane.
